(19) United States
(12) Patent Application Publication
(10) Pub. No.: US 2024/0169514 A1
(43) Pub. Date: May 23, 2024

(54) DEFECT DETECTION IN MANUFACTURED ARTICLES USING MULTI-CHANNEL IMAGES

(71) Applicant: Onto Innovation Inc., Wilmington, MA (US)

(72) Inventors: Longjiang Xiang, Tianjin (CN); Xin Song, Andover, MA (US)

(21) Appl. No.: 18/170,792

(22) Filed: Feb. 17, 2023

Related U.S. Application Data
(63) Continuation-in-part of application No. PCT/CN2022/133325, filed on Nov. 21, 2022.

(51) Int. Cl. G06T 7/00; G01N 21/88; G06V 10/40; G06V 10/764

(52) U.S. Cl. CPC G06T 7/001; G01N 21/8851; G06V 10/40; G06V 10/764; G06T 2207/10152; G06T 2207/20076; G06T 2207/20084; G06T 2207/20224; G06T 2207/30148

(57) ABSTRACT

A system and/or method of detecting a defect in a manufactured article. Images of the manufactured article are generated having different imaging attributes from one another. A multi-channel image is constructed using the images, each image channel of the multi-channel image corresponding to one of the images. The multi-channel image is input to a processor, which determines, based on the input. at least whether the manufactured article includes a defect.

### CROSS-REFERENCE TO RELATED APPLICATIONS

This application claims the benefit of PCT Application No. PCT/CN2022/133325, filed Nov. 21, 2022, the disclosure of which is hereby incorporated herein by reference in its entirety.

### FIELD OF DISCLOSURE

The present disclosure is directed to improving reliability of defect detection in manufactured articles.

### BACKGROUND

Manufactured articles include articles such as semiconductors, light emitting diodes (LEDs), and batteries. Such articles can include fabricated substrates. For some articles, the fabricated substrates can be made from semiconductor material. The substrates of these articles can be manufactured with defects. The defects can be caused by faulty fabrication equipment, poorly calibrated fabrication equipment, environmental conditions, material contamination, and other causes. Correctly identifying defects in manufactured articles or partially manufactured articles is critical to quality control and maximizing output yield of those articles.

As mentioned, manufactured articles can include semiconductor substrates manufactured or fabricated as part of the formation of semiconductor chips, LEDs or batteries, such as solid-state electric vehicle (EV) batteries, which can include multiple layers of electrodes and electrolyte applied through a series of fabrication steps to form a completed battery cell. The components of the article may be applied onto or incorporated into the substrate through a series of fabrication steps. The fabrication steps may include deposition steps where a thin film layer is added onto the substrate. The substrate then may be coated with a photoresist and the circuit pattern of a reticle may be projected onto the substrate using lithography techniques. Etching processes performed with etching tools may then occur.

For the completed article, whether for semiconductor device or another article, to be usable, each tool involved in the substrate fabrication process must perform within a predefined acceptable operation tolerance for the aspect of the article for which that tool is responsible. Tool performance can depend on factors outside of the tools themselves, such as environmental conditions (e.g., ambient light, ambient noise, dust, moisture, and so forth). Inspection tools and measuring tools are used as part of the substrate manufacturing process to ensure that the completed article meets a predefined specification. If even a single tool in the fabrication process is performing outside of its tolerance, a defect in a substrate of the article of sufficient magnitude can result that requires all of the articles or partial articles in that run or subsequent fabrication run to be scrapped, at potentially significant cost.

Inspection processes are used at various steps during a manufacturing process to detect defects on substrates of articles or partially fabricated articles, to drive higher yield in the manufacturing process and thus higher profits. Inspection has always been an important part of fabricating articles, such as semiconductor devices, LEDs and batteries. However, as the dimensions of these types of articles decrease, inspection becomes even more important to the successful manufacture of acceptable articles because smaller defects can cause the articles to fail.

### SUMMARY

In general terms, the present disclosure is directed to constructing a multi-channel image of a manufactured article and determining, based on the multi-channel image, whether the manufactured article includes a defect.

An aspect of the present disclosure provides a method of detecting a defect in a manufactured article, including: receiving images of the manufactured article, the images having different imaging attributes from one another; constructing a multi-channel image using the images, each image channel of the multi-channel image corresponding to one of the images; and determining using Artificial Intelligence, based on the multi-channel image, whether the manufactured article includes a defect.

An aspect of the present disclosure provides a method of detecting a defect in a manufactured article, including receiving images of the manufactured article, the images having different imaging attributes from one another; constructing a multi-channel image using the images, each image channel of the multi-channel image corresponding to one of the images; inputting the multi-channel image to a machine learning model; and determining, using the machine learning model and based on the multi-channel image, whether the manufactured article includes a defect.

In some examples, the manufactured article is a semiconductor substrate. In some examples, the manufactured article is a component of a fully fabricated or partially fabricated device, such as a semiconductor chip, a light emitting diode (LED), or a solid-state battery. In some examples, the substrate represents a component of a solid-state battery for an electric vehicle.

In some examples, the images are generated using a metrology device that scans the manufactured article, such as a light camera, an acoustic camera, a spectrometer, an electron microscope, and so forth. In some examples, the different imaging attributes include different lighting conditions at the substrate and/or at the metrology tool when the images are taken. In some examples, the different imaging attributes include different angles of the metrology tool with respect to the substrate when the images are taken.

Aspects of the present disclosure relate to a system and method configured to inspect semiconductor substrates and other manufactured articles that may include semiconductor substrates, such as light emitting diodes (LEDs), solid state batteries, and so forth, for defects of interest, wherein a probability of the article containing a defect of interest is computed in a multi-channel neural network, wherein the neurons in each layer of each channel are connected to the neurons in a subsequent layer of every other channel of the multichannel neural network.

One aspect of the present disclosure provides a system configured to identify a defect in a manufactured article, including a digital imaging system configured to capture multiple images of a manufactured article, wherein each of the multiple images of the manufactured article is captured under a different lighting condition, an image processor configured to combine the multiple images captured by the digital system into a data array, the data array comprising multiple image channels, wherein each image channel of the multiple image channels comprises an array of numerical values representative of at least one of a color or light level of each pixel for each image of the multiple images of the manufactured article, and a processor configured to receive and process the data array in a multi-channel neural network, wherein each channel of the neural network includes a plurality of layers of neurons, including an input layer and one or more hidden layers, wherein each neuron in each layer is connected to each neuron of a subsequent layer within each channel, and wherein each neuron in each layer is connected to each neuron of a subsequent layer within each of the other channels, wherein the multi-channel neural network further includes an output neuron connected to each neuron of the previous layer for each channel, wherein each neuron of the multi-channel neural network is assigned a bias value, and each connection of the multi-channel neural network is assigned a weight value.

In one embodiment, the output neuron is configured to produce a numerical value representative of a probability of a presence of a defect in the manufactured article. In one embodiment, the captured multiple images include at least a first image wherein light is directed at the manufactured article from a first direction, and a second image wherein light is directed at the manufactured article from a second direction. In one embodiment, the captured multiple images further include a third image wherein light is directed at the manufactured article from a third direction, and a fourth image wherein light is directed at the manufactured article from a fourth direction. In one embodiment, the captured multiple images include at least a first image of the manufactured article under a bright field condition, and a second image of the manufactured article under a dark field condition. In one embodiment, the captured multiple images include at least a first image wherein light is directed at the manufactured article from a first illumination source type, and a second image wherein light is directed at the manufactured article from a second illumination source type. In one embodiment, the captured multiple images include at least one of visible light images, x-ray images, ultraviolet light images, infrared images, images gathered by a scanning electron microscope, or acoustic images.

Another aspect of the present disclosure provides a method of optically inspecting a manufactured article, including capturing multiple digital images of a manufactured article under different lighting conditions; combining the multiple digital images into a data array comprising multiple image channels, wherein each image channel of the multiple image channels comprises an array of numerical values representative of at least one of a color or light level of each pixel for each digital image of the multiple digital images; and determining a probability of a presence of a defect in the manufactured article by processing the data array in a multi-channel neural network, wherein each channel of the neural network includes a plurality of layers of neurons, including an input layer and one or more hidden layers, wherein each neuron in each layer is connected to each neuron of a subsequent layer within each channel, and wherein each neuron in each layer is connected to each neuron of a subsequent layer within each of the other channels, wherein the multi-channel neural network further includes an output neuron connected to each neuron of the previous layer for each channel, wherein each neuron of the multi-channel neural network is assigned a bias value, and each connection of the multi-channel neural network is assigned a weight value.

Another aspect of the present disclosure provides a method of detecting a defect in a manufactured article, including: receiving a first image, a second image, a third image, and a fourth image of the manufactured article, each of the first image, the second image, the third image and the fourth image having different imaging attributes from one another; combining the first image and the second image to form a first modified image; combining the third image and the fourth image to form a second modified image; combining the first modified image and the second modified image to form a third modified image; and determining, based on the third modified image, whether the substrate includes a defect and, if so, a classification of the defect.

Another aspect of the present disclosure provides a method of detecting a defect in a manufactured article, including: receiving a first image of the manufactured article; comparing the first image to a reference image of the substrate to form a difference image, wherein the reference image represents a substrate with no observable defects; comparing the difference image to the reference image to form a mask image; constructing a multi-channel image using the first image, the difference image, and the mask image, each image channel of the multi-channel image corresponding to one of the first image, the difference image, and the mask image; and determining, based on the multi-channel image, whether the substrate includes a defect and, if so, a classification of the defect.

Another aspect of the present disclosure provides a system configured to identify a defect in a manufactured article, including: a digital imaging system configured to capture a plurality of images of the manufactured article, wherein each of the plurality of images of the manufactured article have different imaging attributes from one another; an image processor configured to modify the plurality of images captured by the digital imaging system to construct a multi-channel image, the multi-channel image including a modified image in each channel of the multi-channel image; and a processor configured to determine, based on the multi-channel image, whether the manufactured article includes a defect.

Another aspect of the present disclosure provides a method of detecting a defect in a manufactured article, including: receiving a first image of the manufactured article; comparing the first image to a reference image of the manufactured article to form a difference image, wherein the reference image represents a manufactured article with no observable defects; comparing the difference image to the reference image to form a mask image; constructing a multi-channel image using the first image, the difference image, and the mask image, each image channel of the multi-channel image corresponding to one of the first image, the difference image, and the mask image; and determining, based on the multi-channel image, whether the manufactured article includes a defect.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram depicting a system configured to identify a defect in a manufactured article, in accordance with an embodiment of the disclosure.

FIG. 2A represents an example image captured by the system of FIG. 1 in accordance with an embodiment of the disclosure.

FIG. 2B represents an example image captured by the system of FIG. 1 under different lighting conditions than the image of FIG. 2A in accordance with an embodiment of the disclosure.

FIG. 2C represents an example image captured by the system of FIG. 1 under different lighting conditions than the images of FIGS. 2A and 2B in accordance with an embodiment of the disclosure.

FIG. 2D represents an example image captured by the system of FIG. 1 under different lighting conditions than the images of FIGS. 2A, 2B and 2C in accordance with an embodiment of the disclosure.

FIG. 3A represents an example image captured by the system of FIG. 1 captured under dark-field conditions, in accordance with an embodiment of the disclosure.

FIG. 3B represents an image captured by the system of FIG. 1 under bright-field conditions, in accordance with an embodiment of the disclosure.

FIG. 4 is a schematic diagram depicting a formation of a modified image from two or more images captured by a digital imaging subsystem or other metrology tool, and is depicted in accordance with an embodiment of the disclosure.

FIG. 5 is a schematic diagram depicting a method creating enhanced or modified images from an original image, and is depicted in accordance with an embodiment of the disclosure.

FIG. 6 is a schematic diagram depicting one channel of a neural network, in accordance with an embodiment of the disclosure.

FIG. 7 is a schematic diagram depicting a single neuron of a neural network, in accordance with an embodiment of the disclosure.

FIG. 8 is a schematic diagram depicting a three-channel neural network, in accordance with an embodiment of the disclosure.

FIG. 9 is a profile view of the three-channel neural network of FIG. 6, in which each of the channels is fully connected, in accordance with an embodiment of the disclosure.

FIG. 10 is a method of optically inspecting a manufactured article, in accordance with an embodiment of the disclosure.

### DETAILED DESCRIPTION

What an image of a manufactured article reveals about that article can depend on different attributes of the imaging. For example, a defect in a article may appear in images taken from certain angles or in certain lighting or other ambient conditions, but not in others. That is, different images of the same manufactured article can provide conflicting data on whether there is a defect, what kind of defect it is, and so forth. Typically, there is no intelligent, automated way to reconcile between such conflicting images of the same substrate.

The present disclosure provides an intelligent, automated way to reconcile between images of a manufactured article such as a substrate that provide conflicting information about the presence or absence of a defect on that substrate. In general terms, the present disclosure is directed to constructing a multi-channel image of a manufactured article and determining, based on the multi-channel image, whether the manufactured article includes a defect.

Artificial Intelligence (AI) such as a machine learning model can learn to interpret the multi-channel images and output a determination, based on that interpretation, as to whether a defect is present. In some examples, if a defect is detected from the multi-channel image(s), the AI such as a machine learning model can determine a type or classification of the defect. In some examples, if a defect is detected from the multi-channel image(s), the AI can determine (e.g., by reference to a defect fingerprint library) a tool or other source that caused the defect and output that information. In some examples, if a defect is detected from the multi-channel image(s), the AI can determine (e.g., by reference to a defect fingerprint library) a severity of the defect and output that information. In some examples, if a defect is detected from the multi-channel image(s), the AI can determine (e.g., by reference to a defect fingerprint library) and output a remediation recommendation (e.g., to perform maintenance on a tool, replace a tool, adjust an ambient condition, scrap the substrate, etc.).

Examples of the present disclosure describe systems, methods, and computer-readable products for improving defect detection in substrates of manufactured articles, such as semiconductor substrates and other substrates of semiconductor devices, LEDs, and batteries. Examples of the present disclosure describe systems, methods, and computer-readable products for performing such defect detection.

Reference will now be made in detail to exemplary aspects of the present disclosure that are illustrated in the accompanying drawings. Wherever possible, the same reference numbers will be used throughout the drawings to refer to the same or like parts.

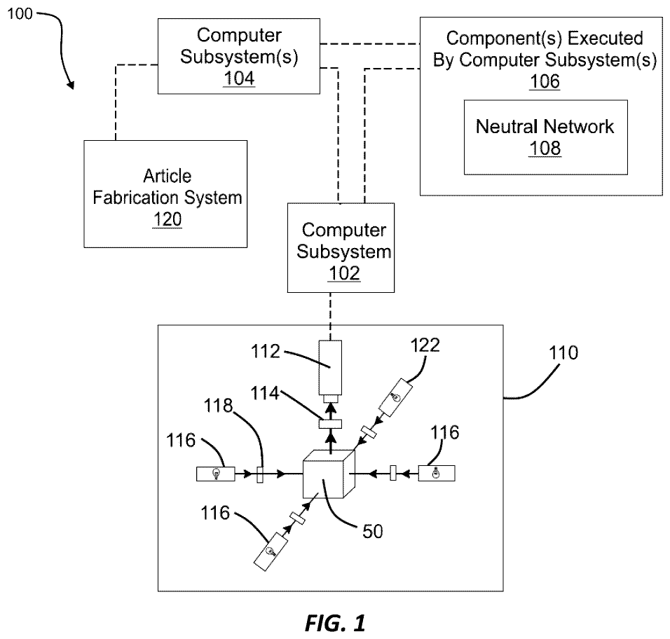

Referring to FIG. 1, a system 100 configured to identify a defect in a manufactured article 50 is depicted in accordance with an embodiment of the disclosure. The article 50 can be a completed article, or an article that has been only partially fabricated. The article 50 can include a semiconductor substrate, such as a semiconductor substrate of an integrated circuit. In some examples, the article 50 can include a light emitting diode (LED), or a portion thereof. In some examples, the article 50 can include a solid-state battery, or a portion thereof. In embodiments, the system 100 can include one or more computer subsystems (e.g., computer subsystems 102, 104) and one or more components executed by the one or more computer subsystems 106. The one or more components can include an AI based machine learning model, specifically a multi-channel neural network 108, as configured and described herein.

In embodiments, the system 100 can include an inspection tool 110, which can include a digital imaging subsystem 112, which in some embodiments can include a camera including suitable optics and an imager such as a CCD or CMOS chip. In some embodiments, the digital imaging subsystem 112 can optionally include one or more lenses 114. For example, in some embodiments, the one or more lenses 114 can serve to magnify an image of the manufactured article 50 (e.g., as part of a microscope). Additionally, in some embodiments the one or more lenses 114 can represent one or more filters or polarizers, employed for nuisance suppression to reduce the presence of certain electromagnetic wavelengths generally associated with observable features on a specimen that do not represent defects on the manufactured article 50.

As depicted, the system 100 can further include a plurality of light sources 116 configured to illuminate the manufactured article 50 from various angles or orientations in an effort to capture a more representative collection of views of the manufactured article 50. For example, in some embodiments, the light sources 116 can generally be directed at the manufactured article 50 from multiple different directions (e.g., any two or more of from above, from below, from the left and from the right). In some embodiments, the light sources 116 can be of different illumination types (e.g., incandescent light, fluorescent light, different spectrums of visible light, ultraviolet, x-ray, infrared, etc.). In some embodiments, one or more filters or lenses 118 can be employed for modification of light emitted from the light source 116.

Accordingly, in embodiments, the digital imaging subsystem 112 can include various types of imaging systems configured to capture images from different perspectives of the manufactured article 50. For example, in some embodiments, the digital imaging subsystem 112 can include a camera configured to capture images represented by light across a broad range of the electromagnetic spectrum (e.g., visible light, ultraviolet light, x-ray, infrared light, etc.). In some embodiments, the digital imaging subsystem 112 can comprise a scanning electron microscope, acoustical imaging device, ultrasound imaging device, or the like.

Although FIG. 1 depicts the system as including four light sources 116, a greater or fewer number of light sources is also contemplated. For example, the light source 116 can be a single source, such as a broadband, white light emitting diode (LED) with optical fibers, mirrors, lenses, or filters to direct electromagnetic radiation from the light source 116 as desired, or multiple sources, with each source covering a different part of the electromagnetic spectrum. The light source 116 may also include a visible light source such as a broadband LED (e.g., a white light LED) that has an emission spectrum that spans across a range of visible wavelengths. In other cases, the light source can be an incandescent lightbulb, or other filament-based light source.

As further depicted in FIG. 1, in some embodiments, the system 100 can incorporate the article fabrication system (or subsystem) 120, such that inspection via the inspection tool 110 is seamlessly integrated into the manufacturing process, which in some embodiments may include one or more rework processes to address defects discovered by the system 100.

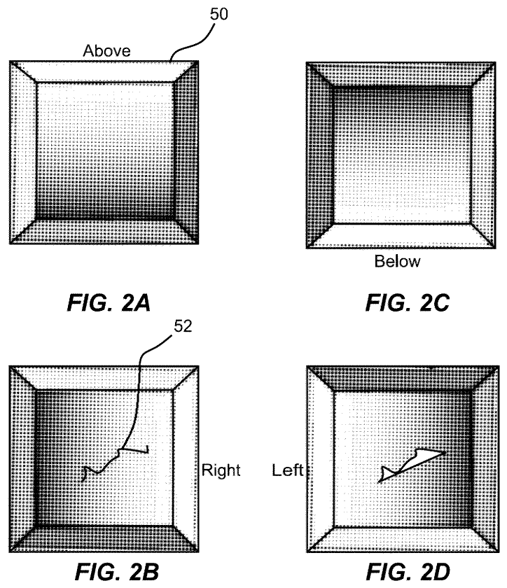

With additional reference to FIGS. 2A, 2B, 2C and 2D, example images captured by the digital imaging subsystem 112 are depicted in accordance with an embodiment of the disclosure. In this particular example, FIG. 2A represents a captured image of a manufactured article 50 with a light source directed from above, FIG. 2B represents a captured image of the same manufactured article 50 with a light source directed from the right, FIG. 2C represents a captured image of the same manufactured article 50 with a light source directed from below, and FIG. 2D represents a captured image of the same manufactured article 50 with a light source directed from the left. The actual projection angles of the light source are merely representative of different angles of illumination of the manufactured article 50, as illumination from some directions may cause defects contained within the manufactured article 50 to be more observable than illuminations from other directions. In some examples, the light source is fixed in position, with multiple cameras that take images from different angles or perspectives.

For example, as depicted in FIG. 2B, when the light source is directed from the right side of the manufactured article 50, a defect 52 may be included in the image captured by the digital imaging subsystem 112, whereas the same defect 52 may not be observable when the light source is directed from above or below. Similarly, when the light source is directed from the left side, certain aspects of the defect 52 may be captured in an image of the manufactured article 50. As seen in a comparison of FIG. 2B and FIG. 2D, where a defect 52 is captured in an image of the manufactured article 50, certain aspects of the defect 52 may differ between the images, such that analyzing all of the images (e.g., FIGS. 2A-D) may provide a more accurate representation of the defect 52.

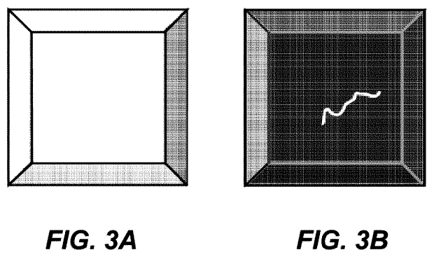

With additional reference to FIGS. 3A and 3B, in another example, the system 100 can capture and analyze images of the manufactured article 50 under bright field and dark field conditions. In embodiments, different approaches to illumination can be used to identify different types of defects or features on a manufactured article 50.

Dark-field illumination (as depicted in FIG. 3A) uses light to produce a bright image against a dark background (e.g., light is directed directly at the subject to fully illuminate the subject). Under dark-field illumination conditions, the manufactured article 50 being imaged appears generally bright, with defects or discontinuities that tend to scatter the light appearing darker than other portions of the article 50 (e.g., non-defective portions of the article 50), particularly where the defects or discontinuities may include angled or rough surfaces, that tend to scatter light, in comparison to other portions of the article 50.

By contrast, bright-field illumination (as depicted in FIG. 3B) uses light to produce a dark image against a bright background (e.g., the background is lit producing a silhouette-like image). Under brightfield illumination conditions, the manufactured article 50 being imaged appears generally dark, occasionally with some portion of the illuminated background passing through the article 50, and defects or discontinuities appearing lighter or darker in contrast to other portions of the article 50 (e.g., non-defective portions of the article 50), particularly where the defects or discontinuities may have a different thickness or different density than other portions of the article 50.

In general, bright-field illumination is useful in illuminating features and variations within the otherwise speculatively reflective substrates that have generally smooth surfaces (e.g., layer boundaries, color variations and the like). Dark-field illumination is useful in illuminating features, particles, and variations in or on the surface of the substrate that are discontinuous or which have features that would tend to scatter light. In the inspection of a manufactured article for the existence of chips, cracks, particles, lines, imprints and process variations, it can be desirable to utilize a combination of bright-field and dark-field illumination.

Images captured by the digital imaging subsystem 112 under the various lighting configurations can be combined (for example via the computer subsystem 102) into a data array including multiple image channels representative of the various captured images, wherein individual elements within each channel can be values representative of the spectral intensity, color, etc. of the individual pixels within a captured image. For example, with reference to FIGS. 2A-2D, if each of the captured images represents a 100×100 pixel image, the four images can be combined to create a three-dimensional numerical array having 100 units along the x-axis, 100 units along the y-axis, and four units along the z-axis, wherein the x- and y-axes represent the number of pixels within each image, and the z-axis represents the number of images. Although FIGS. 2A-D depict the capturing of four images to create a four image channel data array, the array can include as few as two image channels up to as many image channels as desired (e.g., 10's, 100's 1,000's or more), depending on how many different images of the manufactured article having different attributes are captured.

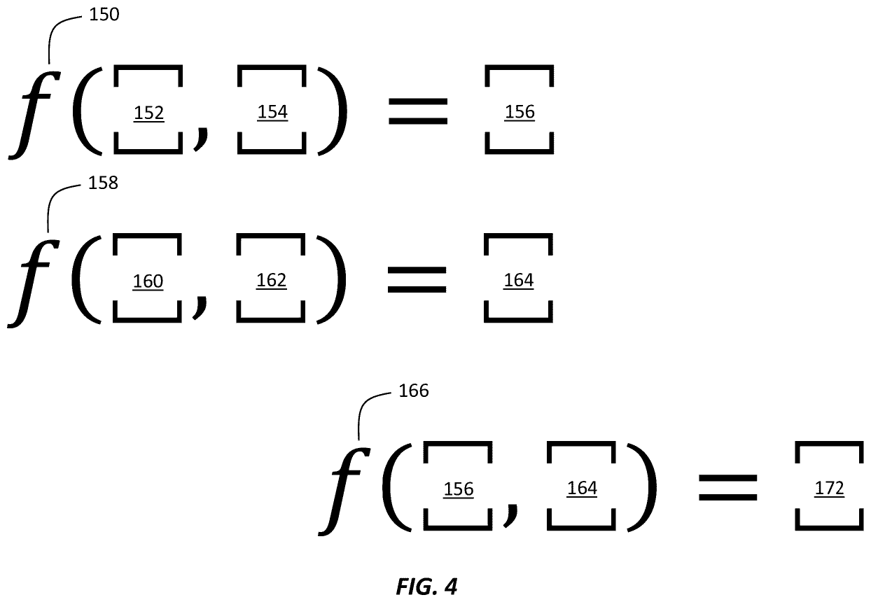

In other embodiments, images captured by the digital imaging system 112 can be combined and processed into a modified image for further analysis by the neural network 108. For example, with additional reference to FIG. 4, the formation of a modified image from two or more images captured by the digital imaging subsystem 112 or other metrology tool 122 is depicted in accordance with an embodiment of the disclosure. As depicted, in one embodiment, a first mathematical function 150 can be performed on a first image 152 and a second image 154 (e.g., RGB values representing pixel data from the first image 152 can be added, subtracted, multiplied, divided, etc. from/by pixel data from the second image 154) to establish a first modified image 156. A second mathematical function 158 can be performed on a third image 160 and a fourth image 162 to establish a second modified image 164. Thereafter, a third mathematical function 166 can be performed on the first modified image 156 and the second modified image 164 to establish a third modified image 164. In some embodiments, the third modified image 164 can be used as an input for further analysis by the neural network 108.

To ensure compatibility between the various images, in some embodiments, various techniques may be employed to ensure proper alignment (e.g., translation, rotation, scale, orthogonality, magnification, etc.) between images. For example, in some embodiments, one or more of the images may be modified for compatibility with other images. Additionally, in some embodiments, one or more noise reduction algorithms may be applied to an image for improved clarity and enhancement of captured features. In some embodiments, data collected by one or more metrology tools can be presented or otherwise formatted into a data array compatible with images captured by the digital imaging subsystem 112.

In some embodiments, the computer subsystem 102 can separate the images into constituent parts using a wavelength specific filter, or one or more sensors using a wavelength specific beam splitter, such that only selected wavelengths are analyzed. In some embodiments, color images having a red, green and blue (RGB) component can be converted to a grayscale, which can then be assigned a numerical value representative of its color or intensity. In another embodiment, the various components (RGB components, etc.) of a single image can be divided, such that each component of the single captured image represents a separate channel for input into the neural network 108. In some embodiments, aspects of the one or more lenses 114 (e.g., aperture, focal length, etc.) can be adjusted to establish the various channels. In some embodiments, aspects of the one or more filters or lenses 118 (e.g., collimated light lenses, bandpass filters, neutral density filters, polarizing filters, infrared filters, etc.) can be adjusted to establish the various channels.

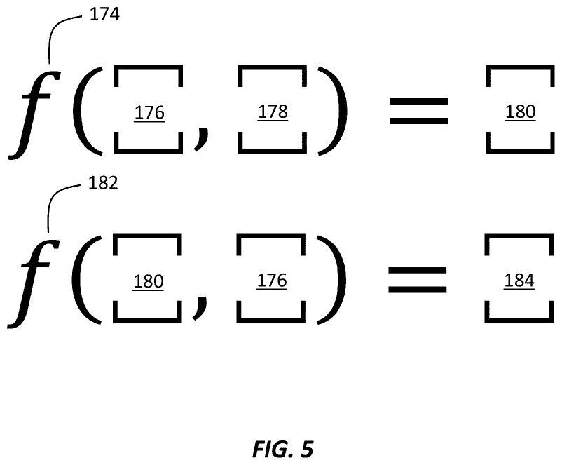

In some embodiments, the computer subsystem 102 can be configured to separate an image into a plurality of constituent parts (e.g., representing an original image, and one or more additional images) as inputs to the neural network 108. For example, with additional reference to FIG. 5, a schematic diagram depicting a method creating augmented or modified images from an original image is depicted in accordance with an embodiment of the disclosure. As depicted, in one embodiment, a first function 174 can be performed on a first image 176, and a reference image 178 to establish a difference image 180. The first image 176 can itself be a multi-channel image like those described herein, where each channel is based on a captured image of an identical region of substrate but under different imaging conditions from the images corresponding to the other channels. In one embodiment, the reference image 178 can represent a substrate with no observable defects (e.g., a computer model representing a perfect specimen, etc.). Values representing pixel data from the first image 176 can be added, subtracted, multiplied, divided, etc. from/by pixel data from the reference image 178, to establish the difference image 180, which in some embodiments can tend to highlight the differences created by defects present on the substrate. As further depicted in FIG. 5, a second function 182 can be performed on the difference image 180 and the first image 176 to establish a mask image 184. Thereafter, the first image 176, difference image 180, and mask image 184 can be formulated into a data array, or augmented multi-channel image, where one channel of the augmented multi-channel image is the first image 176, a second channel of the augmented multi-channel image is the difference image 180, and a third channel of the augmented multi-channel image is the mask image 184. Such an augmented multi-channel image can be processed in a similar fashion to that of the other multi-channel images described herein (e.g., by inputting the augmented multi-channel image into a neural network) to more accurately identify and/or classify defects, and with greater confidence, then with a non-augmented multi-channel image.

The data array can then be input into the neural network 108, for example via computer subsystems 102, 104 or components executed by computer subsystems 106, to compute a probability of the presence or absence of a defect (e.g., chip, crack, scratch, particles, etc.) on the manufactured article 50. In some embodiments, the output can be in terms of a statistical probability in the form of a percentage or likelihood of the presence of a defect. In some embodiments, the neural network 108 can attempt to classify observed defects into one or more groups of classifications, for example, the output of the neural network 108 can be in the form of a statistical probability that any given defect falls within a particular classification of a finite list of user-defined classifications. In other embodiments, the output can be in the form of an image or graphical representation of the article, wherein the image indicates the probability of the presence of a defect on the surface of the manufactured article 50.

Neural networks typically consist of multiple layers, and the signal path traverses from front to back. The multiple layers perform a number of algorithms or transformations. In general, the number of layers is not significant and is use case dependent. For practical purposes, a suitable range of layers is from two layers to a few tens of layers. Modern neural network projects typically work with a few thousand to a few million neural units and millions of connections. The goal of the neural network is to solve problems in the same way that the human brain would, through the use of specific networks pathways which may resemble networks in the human brain. The neural networks may have any suitable architecture and/or configuration known in the art. In some embodiments, the neural networks may be configured as a deep convolutional neural network (DCNN).

The neural networks described herein belong to a class of computing commonly referred to as machine learning. Machine learning can be generally defined as a type of artificial intelligence (AI) that provides computers with the ability to learn without being explicitly programmed. Machine learning focuses on the development of computer programs that can teach themselves to grow and change when exposed to new data. In other words, machine learning can be defined as the subfield of computer science that “gives computers the ability to learn without being explicitly programmed.” Machine learning explores the study and construction of algorithms that can learn from and make predictions on data—such algorithms overcome following strictly static program instructions by making data driven predictions or decisions, through building a model from sample inputs.

The neural networks described herein may also or alternatively belong to a class of computing commonly referred to as deep learning (DL). Generally speaking, “DL” (also known as deep structured learning, hierarchical learning or deep machine learning) is a branch of machine learning based on a set of algorithms that attempt to model high level abstractions in data. In a simple case, there may be two sets of neurons: ones that receive an input signal and ones that send an output signal. When the input layer receives an input, it passes on a modified version of the input to the next layer. In a based model, there are many layers between the input and output (and the layers are not made of neurons but it can help to think of it that way), allowing the algorithm to use multiple processing layers, composed of multiple linear and non-linear transformations.

DL is part of a broader family of machine learning methods based on learning representations of data. An observation (e.g., an image) can be represented in many ways such as a vector of intensity values per pixel, or in a more abstract way as a set of edges, regions of particular shape, etc. Some representations are better than others at simplifying the learning task (e.g., face recognition or facial expression recognition). One of the promises of DL is replacing handcrafted features with efficient algorithms for unsupervised or semi-supervised feature learning and hierarchical feature extraction.

Research in this area attempts to make better representations and create models to learn these representations from large-scale unlabeled data. Some of the representations are inspired by advances in neuroscience and are loosely based on interpretation of information processing and communication patterns in a nervous system, such as neural coding which attempts to define a relationship between various stimuli and associated neuronal responses in the brain.

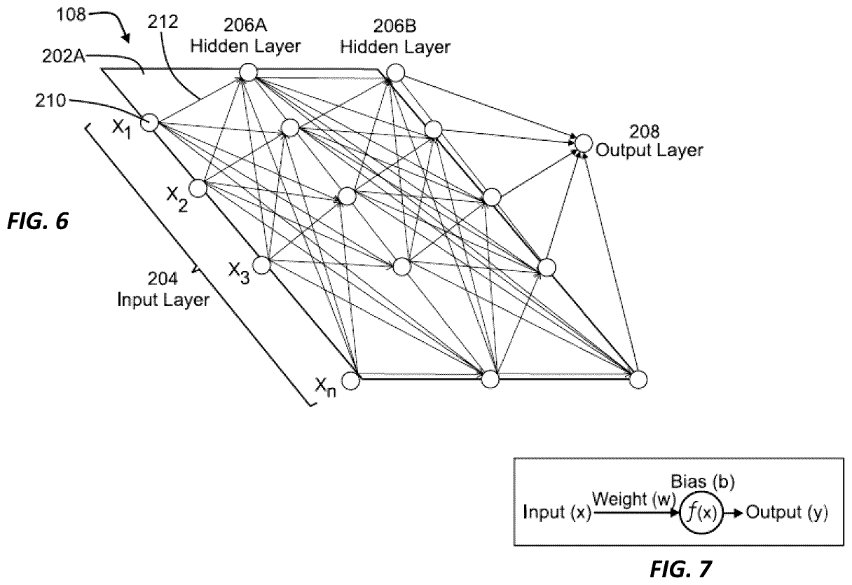

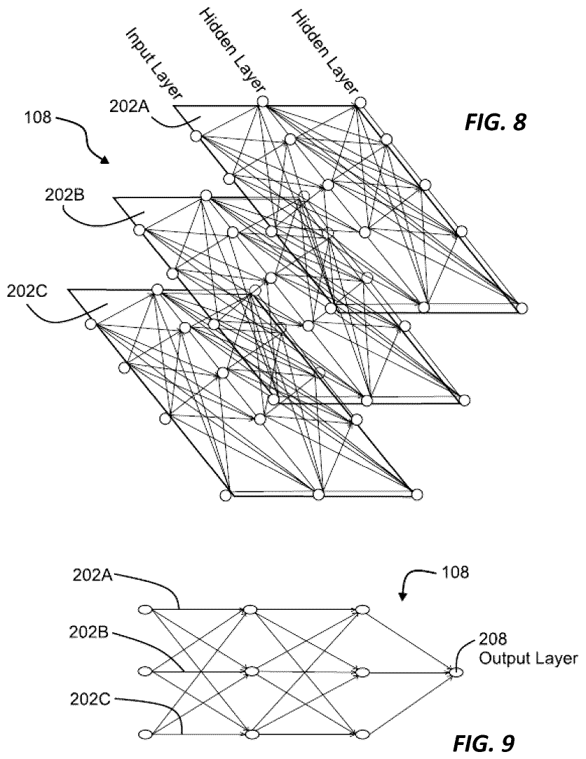

With additional reference to FIG. 6, at a basic level, the neural network 108 can include a plurality of channels 202A-C (see also FIG. 8, depicting three channels), with each channel including an input layer 204 and one or more hidden layers 206A-B, with a single output layer 208 typically shared among the plurality of channels 202A-C. The plurality of channels can include any number of input channels. Each of the layers 204, 206, 208 can include a corresponding plurality of neurons 210. Although only two hidden layers 206A-B are depicted, it is contemplated that the neural network 108 can include as few as one hidden layer or as many hidden layers as desired.

The inputs for the input layer can be any number along a continuous range (e.g., any number between 0 and 255, etc.). For example, in one embodiment, the input layer 204 can include a total of 786,432 neurons corresponding to a 1024×768 pixel output of a digital imaging subsystem 112, wherein each of the input values (e.g., based on a grayscale or RGB color code). In another embodiment, the input layer 204 can include three layers of inputs for each pixel, wherein each of the input values is based on a numerical color code for each of the R, G, and B colors; other quantities of neurons and input values are also contemplated.

Each of the neurons 210 in a given layer (e.g., input layer 204) can be connected to each of the neurons 210 of the subsequent layer (e.g., hidden layer 206A) via a connection 212, as such, the layers of the network can be said to be fully connected. Although it is also contemplated that the algorithm can be organized as a convolutional neural network, wherein a distinct group of input layer 204 neurons (e.g., representing a local receptive field of input pixels) can couple to a single neuron in a hidden layer via a shared weighted value.

With additional reference to FIG. 7, each of the neurons 210 can be configured to receive one or more input values (x) and compute an output value (y). In fully connected networks, each of the neurons 210 can be assigned a bias value (b), and each of the connections 212 can be assigned a weight value (w). Collectively the weights and biases can be tuned as the neural network 108 learns how to correctly classify detected objects. Each of the neurons 210 can be configured as a mathematical function, such that an output of each neuron 210 is a function of the connection weights of the collective input, and the bias of the neuron 210, according to the following relationship:

y≡w·x+b

In some embodiments, output (y) of the neuron 210 can be configured to take on any numerical value (e.g., a value of between 0 and 1, etc.). Further, in some embodiments the output of the neuron 210 can be computed according to one of a linear function, sigmoid function, tan h function, rectified linear unit, or other function configured to generally inhibit saturation (e.g., avoid extreme output values which tend to create instability in the neural network 108).

In some embodiments, the output layer 208 can include neurons 210 corresponding to a desired number of outputs of the neural network 108. For example, in one embodiment, the neural network 108 can include a plurality of output neurons dividing the surface of the manufactured article 50 into a number of distinct regions in which the likelihood of the presence of a defect can be indicated with an output value. Other quantities of output neurons 210 are also contemplated; for example, the output neurons could correspond to object classifications (e.g., comparison to a database of historical images), in which each output neuron would represent a degree of likeness of the present image to one or more historical images of a known defect. The output neuron 210 can output a probability of a defect being included or a plurality of types of defects being included in a manufactured article 50.

With additional reference to FIGS. 6-7, the neural network 108 can include a plurality of channels 202A-202C, with each channel 202A-202C representing an input layer 204 configured to receive data associated with each of the different images captured of the manufactured article 50. As best depicted in FIG. 9, the neurons 210 in each of the channels 202A-C of a given layer (e.g., input layer 204) can be connected to each of the neurons 210 of the subsequent layer (e.g., hidden layer 206A) via connections, such that each of the channels 202A-C can set to be fully connected, with the final hidden layer 206B optionally feeding into a single output layer 208 indicating the probability of the presence of a defect.

The system 100 may be configured for training the neural network 108. Training the neural network 108 may be performed in a supervised, semi-supervised, or unsupervised manner. For example, in a supervised training method, one or more images of the specimen may be annotated with labels that indicate noise or noisy areas in the image(s) and quiet (non-noisy) areas in the image(s). The labels may be assigned to the image(s) in any suitable manner (e.g., by a user, using a ground truth method, or using a defect detection method or algorithm known to be capable of separating defects from noise in the high-resolution images with relatively high accuracy). The image(s) and their labels may be input to the neural network 108 for the training in which the one or more weights and biases are altered until the output layer 208 of the neural network 108 matches the training input.

In some embodiments, the digital imaging subsystem 112 can be used to gather inspection data on a plurality of training articles, having one or more known defects or noisy areas. For example, the digital imaging subsystem 112 can obtain multiple images of the training articles, each of the images generally capturing the same field-of-view but having different attributes (e.g., images captured under different lighting orientations, dark-field illumination, brightfield illumination, visible light images, x-ray images, ultraviolet light images, infrared images, images gathered by a scanning electron microscope, acoustic images, etc.). Similar to that depicted in FIGS. 2A-2D, it is anticipated that some of the images captured of the plurality of training articles will show defects, while other images having a similar field-of-view will not show defects, dependent upon the different attributes under which the image is captured. Thereafter each of the multiple images can be converted to a data array and fed into one the input layers 204 of channel 202A of a corresponding plurality of channels of the neural network 108, wherein the total number of channels matches the total number of images having different attributes. As the neural network 108 processes the training data, the neural network 108 will become tuned to properly identify, distinguish and classify defects and noisy areas through the output layer 208 based on multi-channel images.

The goal of the deep learning algorithm is to tune the weights and balances of the neural network 108 until the inputs to the input layer 204 are properly mapped to the desired outputs of the output layer 208, thereby enabling the algorithm to accurately produce outputs (y) for previously unknown inputs (x). For example, if the digital imaging subsystem 112 captures a digital image of a manufactured article 50 (the pixels of which are fed into the input layer 204), a desired output of the neural network 108 would be the indication of whether further review is desirable. In some embodiments, the neural network 108 can rely on training data (e.g., inputs with known outputs) to properly tune the weights and balances.

In tuning the neural network 108, a cost function (e.g., a quadratic cost function, cross entropy cross function, etc.) can be used to establish how close the actual output data of the output layer 208 corresponds to the known outputs of the training data. Each time the neural network 108 runs through a full training data set can be referred to as one epoch. Progressively, over the course of several epochs, the weights and balances of the neural network 108 can be tuned to iteratively minimize the cost function.

Effective tuning of the neural network 108 can be established by computing a gradient descent of the cost function, with the goal of locating a global minimum in the cost function. In some embodiments, a backpropagation algorithm can be used to compute the gradient descent of the cost function. In particular, the backpropagation algorithm computes the partial derivative of the cost function with respect to any weight (w) or bias (b) in the neural network 108. As a result, the backpropagation algorithm serves as a way of keeping track of small perturbations to the weights and biases as they propagate through the network, reach the output, and affect the cost. In some embodiments, changes to the weights and balances can be limited to a learning rate to prevent overfitting of the neural network 108 (e.g., making changes to the respective weights and biases so large that the cost function overshoots the global minimum). For example, in some embodiments, the learning rate can be set between about 0.03 and about 10. Additionally, in some embodiments, various methods of regularization, such as L1 and L2 regularization, can be employed as an aid in minimizing the cost function.

Accordingly, in some embodiments, the system 100 be configured to utilize pixel data from a digital imaging subsystem 112 as an input for computer subsystems 102, 104 or components executed by the computer subsystems 106 configured to operate a deep learning algorithm for the purpose of automatically assigning a probability that objects viewed by the digital imaging subsystem 112 warrant further review. Although the present disclosure specifically discusses the use of a deep learning algorithm in the form of a neural network 108 to establish the probability of the presence of a defect, other methods of automatic recognition and classification are also contemplated.

Embodiments of the present disclosure are particularly adept at distinguishing between observable nuisances and defects of interest (DOI). For example, the system 100 described herein can perform a kind of iterative training in which training is first performed for nuisance suppression then DOI detection. “Nuisances” (which is sometimes used interchangeably with “nuisance defects”) as that term is used herein is generally defined as defects that a user does not care about and/or events that are detected on a specimen but are not really actual defects on the specimen. Nuisances that are not actually defects may be detected as events due to non-defect noise sources on the specimen (e.g., grain in metal lines on the specimen, signals from underlaying layers or materials on the specimen, relatively small critical dimension (CD) variation in patterned features, thickness variations, etc.) and/or due to marginalities in the inspection subsystem itself or its configuration used for inspection.

The term “DOI” as used herein can be defined as defects that are detected on a specimen and are really actual defects on the specimen. Therefore, the DOIs are of interest to a user because users generally care about how many and what kind of actual defects are on specimens being inspected. In some contexts, the term “DOI” is used to refer to a subset of all of the actual defects on the specimen, which includes only the actual defects that a user cares about. For example, there may be multiple types of DOIs on any given manufactured article 50, and one or more of them may be of greater interest to a user than one or more other types. In the context of the embodiments described herein, however, the term “DOIs” is used to refer to any and all real defects on a manufactured article 50.

Generally, therefore, the goal of inspection is not to detect nuisances on manufactured articles 50. Despite substantial efforts to avoid such detection of nuisances, it is practically impossible to eliminate such detection completely. Therefore, it is important to identify which of the detected events are nuisances and which are DOIs such that the information for the different types of defects can be used separately, e.g., the information for the DOIs may be used to diagnose and/or make changes to one or more fabrication processes performed on the specimen, while the information for the nuisances can be ignored, eliminated, or used to diagnose noise on the specimen and/or marginalities in the inspection process or tool.

Where conventional vision systems in the past may have employed a neural network to classify and identify DOIs, previous efforts have been restricted to an analysis of a single captured image, or in some cases, a sequence of several captured images of the manufactured article, with each image being analyzed independently. Unfortunately, such conventional systems were subject to error, particularly where one analyzed image captures a DOI, and a subsequent image of the manufactured article fails to capture the DOI.

By contrast, embodiments of the present disclosure enable the simultaneous analysis of multiple images of a manufactured article having different imaging attributes from one another. Analyzing the multiple images simultaneously enables the neural network to evaluate connections between the different images on a granular (e.g., pixel) basis, resulting in improved reliability, particularly where the DOI only partially appears in a portion of the captured images.

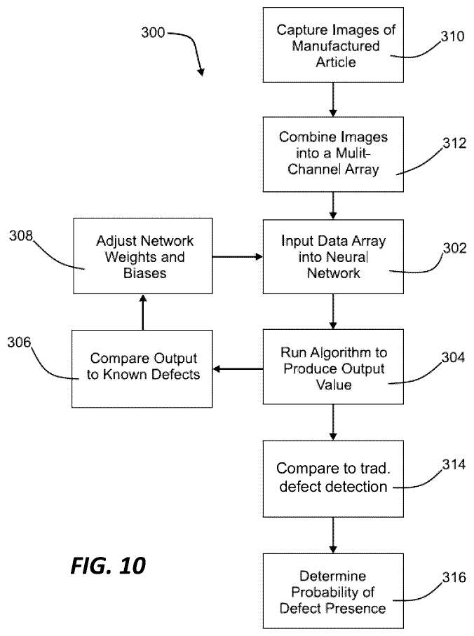

Referring to FIG. 10, a method 300 of optically inspecting a manufactured article 50 is depicted in accordance with an embodiment of the disclosure. In some embodiments, the method can include an iterative training loop, comprising inputting the data array into the neural network, at step 302. At step 304, the neural network 108 can be run to produce one or more output values, which at step 306, can be compared to known defects in order to evaluate the performance of the neural network 108. Based on the evaluation, at step 308, the various weights and biases of the neural network 108 can be adjusted, and the training loop (e.g., steps 302, 304, 306, and 308) can be repeated. In some embodiments, the training loop can be repeated until the adjustments to the weights and biases falls below a given threshold and/or the output of the neural network 108 is deemed to perform within a desired accuracy range.

Thereafter, the neural network 108 can be configured to receive and process real-world imaging data (e.g., non-training data) for evaluation of manufactured articles 50 for the presence or absence of defects of interest. Specifically, at step 310, images of a manufactured article 50 can be captured, wherein the images of the manufactured article are captured under different lighting conditions and/or different camera setting, filter or lens conditions. At step 312, the images can be combined into a data array comprising multiple channels, wherein each channel of the multiple channeled array comprises an array of numerical values representing the pixels for each image or modified image, including augmentations thereto, as described above. At step 302, the data array can be input into the neural network 108, and the neural network as an algorithm can be run to produce an output value or a plurality of output values, where the output values are probabilities for each of a finite set of defect classifications. At step 314, the output value or plurality of output values can optionally be compared to the output or plurality of outputs of another inspection technique, which can employ automated software and equipment to analyze images, detect defects, and classify the type of defect.

Where an agreement is reached between the output value or plurality of output values of the neural network and the output or plurality of values of another inspection technique, at step 316, the system 100 can be used to determine a probability of the presence of a defect on the manufactured article. The neural network 108 and the other inspection technique can each also output a plurality of values that each include a numerical probability of a type of defect and each can employ image processing techniques such as denoising, filtering, cropping, alignment of images, etc. The image processing techniques can be used to ensure that all of the images are of the same region of the substrate or article of manufacture. Another inspection technique(s) typically involve performing image processing on images of a substrate or article of manufacture, followed by feature extraction from the processed images, followed by classification of the extracted features. Thus, for example, if, for a given substrate, the classification output values of both the another inspection technique of the neural network are in agreement, or are in agreement within a predefined tolerance, then there is sufficient confidence that the outputs are correct and the defect classification(s) is/are accepted. If, on the other hand, for a given substrate, the defect classification output values of both the other inspection technique and the neural network are not in agreement then there is insufficient confidence that the outputs are correct and the defect classification(s) is/are rejected.

Based on the determined probability, the neural network 108 can provide one or more further outputs based on its analysis of the multi-channel image and comparing a detected defect to reference defects and corresponding metadata (e.g., tool data corresponding to reference defect data) of a defect fingerprint library. Such further outputs of the neural network 108 can include, for example, a type of the defect, the identity of a tool or other source that caused the defect, a severity of the defect, and/or a defect remediation recommendation (e.g., to perform maintenance on a tool, replace a tool, adjust an ambient condition, scrap the substrate, etc.).

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A method of detecting a defect in a manufactured article, comprising:
receiving images of the manufactured article, the images having different imaging attributes from one another;
constructing a multi-channel image using the images, each image channel of the multi-channel image corresponding to one of the images; and
determining, using Artificial Intelligence, based on the multi-channel image, whether the manufactured article includes a defect.

2. The method of claim 1, wherein the multi-channel image includes using a first image from the images of the manufactured article, a difference image, and a mask image, each image channel of the multi-channel image corresponding to one of the first image, the difference image, and the mask image.

3. The method of claim 1, wherein the manufactured article includes at least one of a semiconductor chip, a light emitting diode (LED), and a solid-state battery.

4. The method of claim 1, wherein the images are generated using a metrology device that scans the manufactured article, such as a light camera, an acoustic camera, a spectrometer, or an electron microscope.

5. The method of claim 1, wherein the different imaging attributes include different lighting conditions at the manufactured article and/or at a metrology tool when the images are taken.

6. The method of claim 1, wherein the Artificial Intelligence is performed using a neural network.

7. The method of claim 1, wherein the different imaging attributes include different angles of a metrology tool with respect to the manufactured article when the images are taken.

8. The method of claim 1, wherein the images are all of an identical region of the manufactured article.

9. A system for detecting a defect, comprising:
at least one processor; and
non-transitory computer-readable memory storing instructions thereon that, when executed by the at least one processor, cause the at least one processor to:
receive images of a manufactured article, the images having different imaging attributes from one another;
construct a multi-channel image using the images, each image channel of the multi-channel image corresponding to one of the images; and
determine, using Artificial Intelligence, based on the multi-channel image, whether the manufactured article includes a defect.

10. The system of claim 9, wherein the images are all of an identical region of the manufactured article.

11. A system configured to identify a defect in a manufactured article, comprising:
a digital imaging system configured to capture a plurality of images of the manufactured article, wherein each of the plurality of images of the manufactured article have different imaging attributes from one another;
an image processor configured to modify the plurality of images captured by the digital imaging system to construct a multi-channel image, the multi-channel image including a modified image in each channel of the multi-channel image; and
a processor configured to determine, based on the multi-channel image, whether the manufactured article includes a defect.

12. The system of claim 11, wherein the processor determines whether the manufactured article includes a defect by using a multi-channel neural network, where each channel of the multi-channel neural network includes a plurality of layers of neurons, including an input layer and one or more hidden layers, wherein each neuron in each layer is connected by a connection to each neuron of a subsequent layer within each channel, and wherein each neuron in each layer is connected by the connection to each neuron of the subsequent layer within each of the channels, wherein the multi-channel neural network further includes an output neuron connected to each neuron of a previous layer for each channel, wherein each neuron of the multi-channel neural network is assigned a bias value, and each connection of the multi-channel neural network is assigned a weight value.

13. The system of claim 12, wherein the output neuron is configured to produce a numerical value representative of a probability of a presence of a defect in the manufactured article.

14. The system of claim 11, wherein the plurality of images include at least a first image wherein light is directed at the manufactured article from a first direction, and a second image wherein light is directed at the manufactured article from a second direction different from the first direction.

15. The system of claim 14, wherein the plurality of images further include a third image wherein light is directed at the manufactured article from a third direction different from the first direction and different from the second direction, and a fourth image wherein light is directed at the manufactured article from a fourth direction different from the first direction and different from the second direction and different from the third direction.

16. The system of claim 11, wherein the multiple images captured include at least a first image of the manufactured article under a bright field condition, and a second image of the manufactured article under a dark field condition.

17. The system of claim 11, wherein the multiple images captured include at least a first image wherein light is directed at the manufactured article from a first illumination source type, and a second image wherein light is directed at the manufactured article from a second illumination source type.

18. The system of claim 11, wherein the multi-channel image includes using a first image from the images of the manufactured article, a difference image, and a mask image, each image channel of the multi-channel image corresponding to one of the first image, the difference image, and the mask image.

19. A method of detecting a defect in a manufactured article, comprising:
receiving a first image of the manufactured article;
comparing the first image to a reference image of the manufactured article to form a difference image, wherein the reference image represents a manufactured article with no observable defects;
comparing the difference image to the reference image to form a mask image;
constructing a multi-channel image using the first image, the difference image, and the mask image, each image channel of the multi-channel image corresponding to one of the first image, the difference image, and the mask image; and
determining, based on the multi-channel image, whether the manufactured article includes a defect.

20. The method of claim 19, wherein the manufactured article is at least one of a semiconductor chip, a light emitting diode (LED), and a solid-state battery.

21. The method of claim 19, wherein the determining is performed using Artificial Intelligence.

22. The method of claim 21, wherein the Artificial Intelligence is a neural network that is configured to produce a numerical value representative of a probability of a presence of a defect in the manufactured article.

23. The method of claim 19, wherein the images are all of an identical region of the manufactured article.

24. The method of claim 19, further comprising:
inputting the multi-channel image to a neural network to generate a first output classification probability;
processing an image of the manufactured article to generate a processed image;
extracting a feature from the processed image to generate an extracted feature;
classifying the extracted feature, including generating a second output classification probability;
comparing the first output classification probability and the second output classification probability; and
based on the comparing, accepting or rejecting a classification of a defect of the manufactured article.
